(19) United States
(12) Patent Application Publication
(10) Pub. No.: US 2017/0275151 A1
(43) Pub. Date: Sep. 28, 2017

(54) RIDDING STIRRUPS WITH DETACHABLE FOOT BEDS

(71) Applicant: Shano Group, LLC, Missoula, MT (US)

(72) Inventor: David Shano, Gilbert, AZ (US)

(21) Appl. No.: 15/466,618

(22) Filed: Mar. 22, 2017

Related U.S. Application Data
(60) Provisional application No. 62/311,842, filed on Mar. 22, 2016.

(51) Int. Cl. B68C 3/00

(52) U.S. Cl. CPC B68C 3/00; B68C 2003/0033; B68C 2003/0091

(57) ABSTRACT

Riding stirrups each comprising a hoop and a foot bed removably attached to the hoop by at least one set of coupling mechanisms are disclosed. An exemplary hoop comprises a curved top portion and a bottom portion. An exemplary foot bed comprises a top surface and a bottom surface with a traverse channel. A preferred traverse channel is configured to receive the bottom portion of the exemplary hoop. The exemplary hoop and foot bed are detachably coupled by a set of coupling mechanisms including at least a first coupling mechanism and at least a second coupling mechanism, located at the bottom portion of the hoop and the traverse channel of the foot bed respectively. A preferred set of coupling mechanism is a ball detent system. An exemplary foot bed may further include removable anti-slip projections on its top surface.

### CROSS-REFERENCE TO RELATED APPLICATION

The present application claims priority to a co-pending United States provisional patent application entitled “RIDDING STIRRUPS WITH DETACHABLE FOOT BEDS” having Ser. No. 62/311,842, filed on Mar. 22, 2016, which is entirely incorporated herein by reference.

### BACKGROUND

Stirrups support a rider's feet and balance when riding on an animal. Although stirrups do not tend to wear out and generally require little maintenance, riders sometimes need to change stirrups for comfort or for aesthetic reasons because the foot beds do not fit in that riding occasion.

Generally, different riders have different preferences about the foot beds of their stirrups. Some prefer wider foot beds while others like their foot beds to be more fitting. Some prefer foot beds with greater depths while others might want thinner foot beds. Even for the same rider, the preference may change due to the type of shoes the rider is wearing. In addition to comfort, stirrup designs also serve decorative purposes. A rider may from time to time feel like switching foot beds of the stirrups to add some personal touch.

Existing solutions for personalizing stirrups require either professional help for switching foot beds or replacing the whole stirrups. It is desirous to have stirrups that have detachable foot beds for a layperson to easily switch to fit his/her needs at that time. Having multiple foot beds for replacement instead multiple stirrups help saving money too.

### SUMMARY

The structure, overall operation and technical characteristics of the present invention will become apparent with the detailed description of preferred embodiments and the illustration of the related drawings as follows.

The invention is incorporated in riding stirrups each comprising a hoop and a foot bed removably attached to the hoop by a set of coupling mechanisms. An exemplary hoop comprises a curved top portion and a flat bottom portion. The bottom portion preferably has at least one first coupling mechanism.

An exemplary foot bed of a riding stirrup comprises a top surface and a bottom surface that has a traverse channel. A preferred traverse channel is located at or near the center of mass of the exemplary foot bed and configured to receive the bottom portion of the exemplary hoop. The preferred traverse channel comprises at least one second coupling mechanism configured to mate with the first coupling mechanism of the exemplary hoop. The first and second coupling mechanisms together constitute the set of coupling mechanisms that removably couples the exemplary hoop and foot bed.

A suitable set of coupling mechanisms can be any fastening systems as long as it allows a user to easily attach and detach the hoop and the foot bed. A preferred set of coupling mechanisms is a ball detent system including at least one ball plunger and at least one corresponding ball detent. For this preferred set of coupling mechanisms, the first coupling mechanism can be the ball plunger while the second coupling mechanism is the ball detent, or vice versa. Another preferred set of coupling mechanisms is an alternate ball detent system including multiple ball plungers and one or more grooves as the ball detents. Yet another exemplary set of coupling mechanisms may use magnets on the hoop and/or the foot bed.

A preferred foot bed further comprises a top surface with at least one removable anti-slip projection or traction pin. The anti-slip projection of the preferred foot bed may have various configurations. The head of an exemplary anti-slip projection may be of the shape of a spike or mushroom. The bottom of the exemplary anti-slip projection may be partially threaded to be driven into a hole on the foot bed. Alternatively, the bottom of the exemplary anti-slip projection may be made of elastic material and configured to detachably plug into a hole on the foot bed. Another exemplary anti-slip projection may comprise a magnet at its bottom or be made of magnetic material for coupling with a magnetic foot bed.

An exemplary foot bed may further comprise a top surface with a ramp at the rear end. The ramp preferably slopes downward so that a rider's boot can easily slide into the exemplary stirrup. A preferred angle of the ramp is 45° but an angle between 30° to 60° is also acceptable.

One object of this invention is to provide a riding stirrup with a foot bed that can be easily attached and detached for replacement.

Another object of this invention is to provide a riding stirrup that has anti-slip projections on the top surface of the foot bed and the projections may be easily replaced.

One object of this invention is to provide enhanced ingress for a rider's boot to easily slide in and out of the riding stirrup.

### BRIEF DESCRIPTION OF THE DRAWINGS OR PICTURES

FIG. 1 shows a top back perspective view of an embodiment of a stirrup.

FIG. 2 shows a side view of the embodiment in FIG. 1.

FIGS. 3A-3D depict various views of a hoop of an alternate embodiment of a stirrup.

FIGS. 4A-4E show various views of a foot bed of the embodiment in FIGS.

3A-3D.

FIGS. 5A-5B show a side view and a bottom plan view of an exemplary anti-slip projection.

FIGS. 6A-6B show a side view and a bottom perspective views of another exemplary anti-slip projection.

### DESCRIPTION OF THE EMBODIMENTS

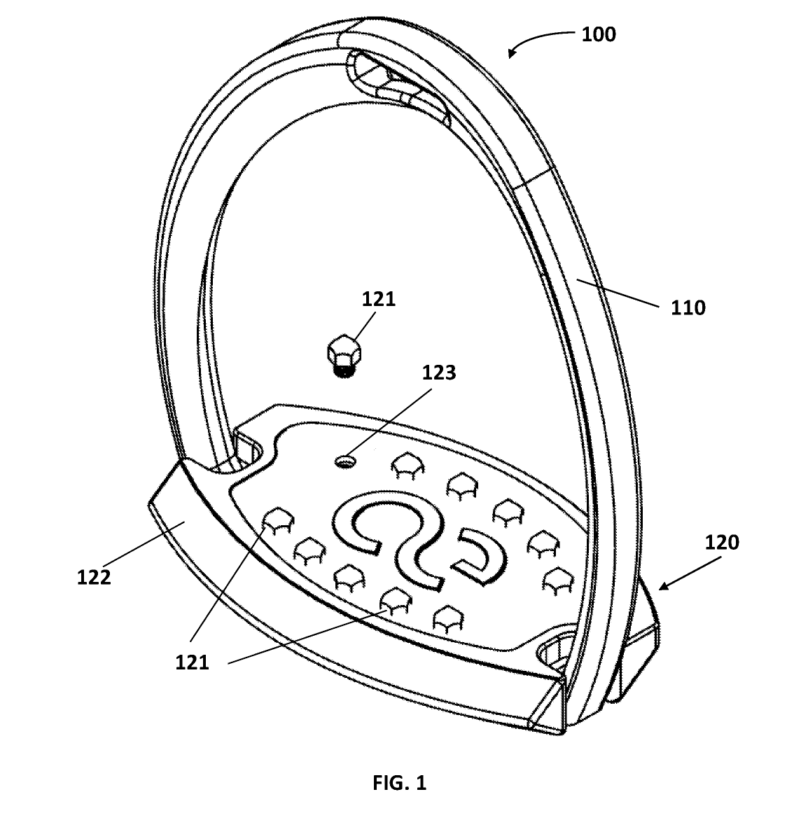

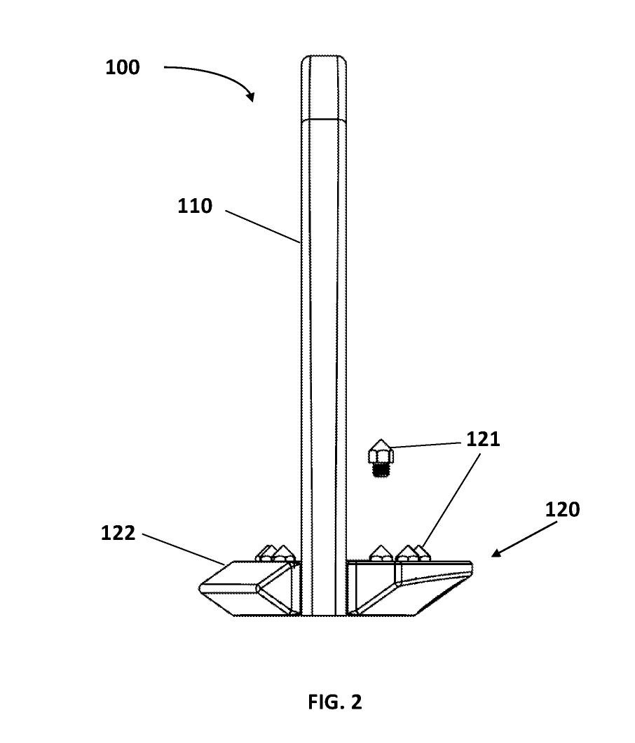

The preferred embodiments include ridding stirrups with hoops and interchangeable foot beds as illustrated in FIGS. 1-6. FIGS. 1-2 and 6A-6B show an embodiment (100) of the ridding stirrup that has an iron hoop (110) removably, snuggly coupled to a foot bed (120) with one or more anti-slip projections (121), a ramp (122), and one or more receptacles (123) configured to detachably receive the anti-slip projections (121).

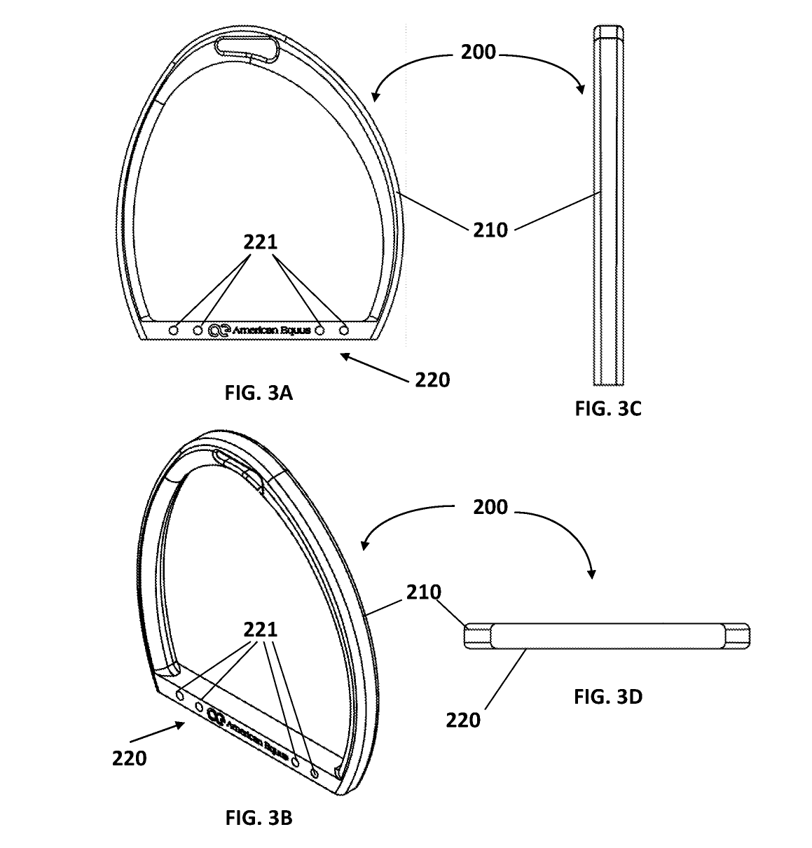

Another preferred embodiment of the riding stirrup is shown in FIGS. 3-6. This embodiment also comprises a hoop (200) and a foot bed (300) that may be removably attached together. The hoop (200) in FIGS. 3A-3D has a curved top portion (210) and a flat bottom portion (220). The bottom portion (220) has multiple first coupling mechanisms (221), ball plungers in this embodiment (with only the balls partially visible), embedded at its sides.

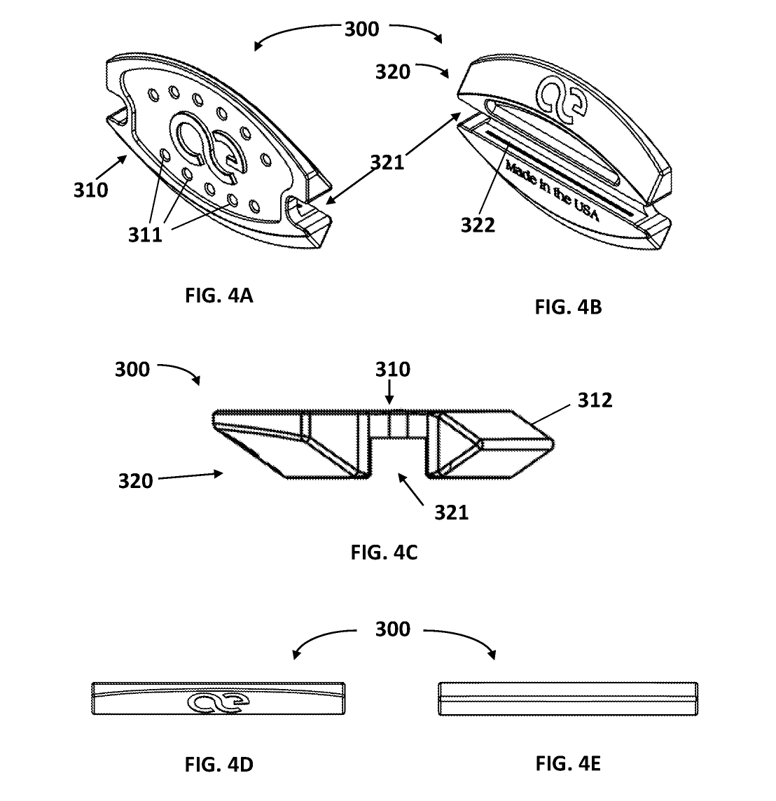

The foot bed (300) of this embodiment, shown in FIGS. 4A-4E, comprises a top surface (310) and a bottom surface (320). The bottom surface (320) has a traverse channel (321) crossing the bottom surface (320) from left to right. The channel (321) is configured to snuggly receive the bottom portion (220) of the hoop (200) and generally as wide and as high as the bottom portion (220). The channel (321) of this embodiment has two second coupling mechanisms (322), i.e. grooves as ball detents in this embodiment, located at the two sidewalls of the channel (321). The second coupling mechanisms (322) are properly sized and configured to removably mate with the first coupling mechanisms (221).

When the foot bed (300) is to be mounted onto the bottom portion (220) of the hoop (200), the user first aligns the channel (320) with the bottom portion (220). Then the user presses the foot bed (300) down and causes the balls of the ball plungers (221) slide into the sockets (not shown, hidden inside the bottom portion (220)) against the pressure of the springs (not shown) located in the sockets. The balls of the ball plungers (221) are pressed into the sockets until the balls are in line with the grooves (322). The grooves (322) preferably have a width slightly smaller than the diameter of the balls. Therefore, the balls partially fall into the grooves (322) under the pressure of the springs, and thus the foot bed (300) and the hoop (200) are temporarily coupled together.

The user may remove the foot bed (300) from the hoop (200) by pulling the foot bed (300) upward. Since the balls of the ball plungers (221) are only partially inside the grooves (322), the balls would be forced to slide out of the grooves (322) and then the foot bed (300) is detached from the hoop (200).

The channel (321) of the foot bed (300) in this preferred embodiment is not uniform in width. As shown in FIGS. 4A-4C, the channel (321) has wider openings on the two ends so that the channel (321) can easily slide onto the bottom portion (220) of the hoop (200).

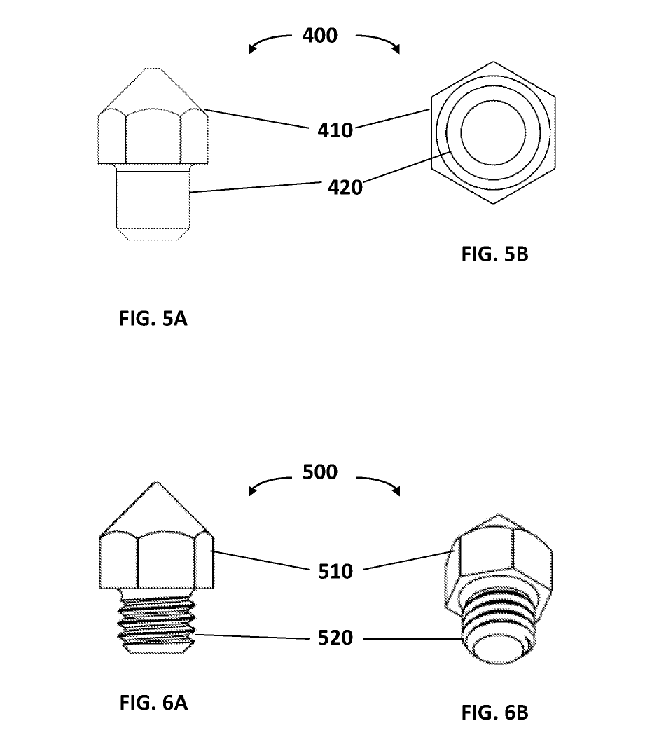

In this preferred embodiment, the top surface (310) of the foot bed (300) has an angled ramp (312) at the rear end of the top surface (310). With the angled ramp (312) sloping downward, a rider's boot can easily slide into/out of the embodiment. Additionally, the top surface (310) of the foot bed (300) of this embodiment comprises multiple receptacles (311) configured to removably mate with anti-slip projections, such as the traction pin (400) in FIGS. 5A-5B or the traction pin (500) in FIGS. 6A-6B.

The exemplary traction pin (400) in FIGS. 5A-5B has a spike head (410) and a short rod portion (420) configured to removably mate with a receptacle (311) on the top surface (310). The alternate exemplary traction pin (500) in FIGS. 6A-6B includes a pointed head (510) and a rod portion (520) with external threads to detachably mate with a receptacle (123 in FIG. 1 or 311 in FIG. 4A) if the receptacle (123 in FIG. 1 or 311 in FIG. 4A) is internally threaded. The top surface (310) of the foot bed (300) may further include an anti-slip cover such as rubber for providing enhanced traction.

While the invention has been described by means of specific embodiments, numerous modifications and variations could be made thereto by those ordinarily skilled in the art without departing from the scope and spirit disclosed herein. For instance, the foot bed and the hoop of an embodiment may be removably attached by any suitable fast coupling/releasing mechanisms known in the art such as hook-and-loop fasteners. The anti-slip projections on the foot bed's top surface of an alternate embodiment may be made of various suitable materials such as metal or rubber and can be of various shapes such as a mushroom-headed bolt and a plug with a figurine head. The angled ramp of the foot bed's top surface in an embodiment may be of any suitable angles such as 45° or 30° downward.

What is claimed is:

1. A riding stirrup comprising:
(a) A hoop comprising:
(i) A bottom portion with at least one first coupling mechanism, and
(ii) A curved top portion coupled to the bottom portion; and
(b) A foot bed detachably coupled to the hoop, the foot bed comprising:
(i) A top surface configured to support a foot, and
(ii) A bottom surface comprising a traverse channel configured to snuggly receive at least a portion of the bottom portion of the hoop and having at least one second coupling mechanism configured to removably mate with the first coupling mechanism.

2. The riding stirrup of claim 1, wherein the at least one first coupling mechanism is selected from one of a ball plunger or a ball detent, and the at least one second coupling mechanism is selected from another one of the ball plunger or the ball detent.

3. The riding stirrup of claim 1, wherein the traverse channel is located at or near a center of mass of the foot bed.

4. The riding stirrup of claim 1, wherein the at least one first coupling mechanism and at least one second coupling mechanism are magnetically attracted to each other.

5. The riding stirrup of claim 1, wherein the top surface of the foot bed further comprises at least one removable anti-slip projection.

6. The riding stirrup of claim 5, wherein the at least one removable anti-slip projection is partially threaded and configured to be removably threaded into a hole in the top surface of the foot bed.

7. The riding stirrup of claim 5, wherein the at least one removable anti-slip projection is at least partially elastic and configured to be removably inserted into a hole in the top surface of the foot bed.

8. The riding stirrup of claim 5, wherein the at least one removable anti-slip projection comprises an enlarged head and a rod portion coupled to the head and configured to removably couple to the top surface of the foot bed.

9. The riding stirrup of claim 8, wherein the enlarged head of the at least one removable anti-slip projection comprises a pointed top end.

10. The riding stirrup of claim 1, wherein the top surface of the foot bed further comprises a ramp located at a rear end of the top surface and sloping downward.

11. A riding stirrup comprising:
(a) A hoop comprising:
(i) A bottom portion with at least one first coupling mechanism, and
(ii) A curved top portion coupled to the bottom portion; and
(b) A foot bed detachably coupled to the hoop, the foot bed comprising:
(i) A top surface configured to support a foot and comprising at least one removable anti-slip projection, and
(ii) A bottom surface comprising a traverse channel configured to snuggly receive at least a portion of the bottom portion of the hoop and having at least one second coupling mechanism configured to removably mate with the first coupling mechanism.

12. The riding stirrup of claim 11, wherein the at least one first coupling mechanism is selected from one of a ball plunger or a ball detent, and the at least one second coupling mechanism is selected from another one of the ball plunger or the ball detent.

13. The riding stirrup of claim 11, wherein the at least one first coupling mechanism and at least one second coupling mechanism are magnetically attracted to each other.

14. The riding stirrup of claim 11, wherein the traverse channel is located at or near a center of mass of the foot bed.

15. The riding stirrup of claim 11, wherein the at least one removable anti-slip projection is partially threaded and configured to be removably threaded into a hole in the top surface of the foot bed.

16. The riding stirrup of claim 11, wherein the at least one removable anti-slip projection is at least partially elastic and configured to be removably inserted into a hole in the top surface of the foot bed.

17. The riding stirrup of claim 11, wherein the at least one removable anti-slip projection comprises an enlarged head and a rod portion coupled to the head and configured to removably couple to the top surface of the foot bed.

18. The riding stirrup of claim 17, wherein the enlarged head of the at least one removable anti-slip projection comprises a pointed top end.

19. The riding stirrup of claim 11, wherein the top surface of the foot bed further comprises a ramp located at a rear end of the top surface and sloping downward.

20. A riding stirrup comprising:
(a) A hoop comprising:
(i) A bottom portion with at least one first coupling mechanism, and
(ii) A curved top portion coupled to the bottom portion; and
(b) A foot bed detachably coupled to the hoop, the foot bed comprising:
(i) A top surface configured to support a foot and comprising at least one removable anti-slip projection, and
(ii) A bottom surface comprising a traverse channel configured to snuggly receive at least a portion of the bottom portion of the hoop and having at least one second coupling mechanism configured to removably mate with the first coupling mechanism, wherein
the at least one first coupling mechanism is selected from one of a ball plunger or a ball detent, and the at least one second coupling mechanism is selected from another one of the ball plunger or the ball detent.
